(19) United States
(12) Patent Application Publication
(10) Pub. No.: US 2013/0192286 A1
(43) Pub. Date: Aug. 1, 2013

(54) HIGH EFFICIENCY ENERGY TRANSFER FROM WASTE WATER TO BUILDING HEATING AND COOLING SYSTEMS

(71) Applicants: Anmin Wang, Tianjin (CN); Wei Wang, Princeton, NJ (US); Andy Fei, Mt. Laurel, NJ (US)

(72) Inventors: Anmin Wang, Tianjin (CN); Wei Wang, Princeton, NJ (US); Andy Fei, Mt. Laurel, NJ (US)

(73) Assignee: NOVATHERMAL ENERGY, LLC, Philadelphia, PA (US)

(21) Appl. No.: 13/641,472

(22) PCT Filed: Apr. 19, 2011
(86) PCT No.: PCT/US11/32977

§ 371 Date: Dec. 27, 2012

Related U.S. Application Data
(60) Provisional application No. 61/325,815, filed on Apr. 19, 2010.
(60) Provisional application No. 61/333,755, filed on May 12, 2010.

(51) Int. Cl. F25B 30/06; C02F 1/00

(52) U.S. Cl. CPC F25B 30/06; C02F 1/001
USPC 62/238.7; 210/333.01; 210/784; 210/774

(57) ABSTRACT

Disclosed are self-cleaning waste water nitration devices suitable for generating thermal water for use in heat pump systems. Also disclosed are methods for continuously generating filtered thermal water from waste water. Further disclosures pertain to systems for automatically generating heating capacity or cooling capacity from a waste water source. Methods for producing and transporting filtered thermal water from a waste water source to a heat pump are also disclosed in which the filtered thermal water can be used for heating, cooling, or both.

### CROSS-REFERENCE TO RELATED APPLICATIONS

This application, claims the benefit of priority to U.S. Provisional Patent Application Ser. No. 61/325,815, filed Apr. 19, 2010 and U.S. Provisional Patent Application Ser. No. 61/333,755, filed May 12, 2010, which applications are herein incorporated by reference in their entirety for all purposes.

### TECHNICAL FIELD

The disclosed inventions pertain to heat pumps. The disclosed technology also pertains to recovering waste heat. The disclosed technology also pertains to filtration of waste water.

### BACKGROUND

Society uses billions of gallons of water every day and converts it to waste water. Homes, buildings, factories, schools, and institutions release a large proportion of this water into sewers, treatment plants and, unfortunately, the environment. Frequently, this waste water is relatively warmer or copier than the environment. Hence, there is a desire to be able to use the heating capacity or the cooling capacity of waste water, as well as geothermal water from the environment for heating or cooling purposes, e.g., as a thermal fluid for heating or cooling source for use in heat pumps for heating or cooling buildings, potable water systems, and the like.

While current geothermal heat pump technology is energy efficient, it has a high first cost of installation and is often infeasible in cities. Traditional geothermal systems require a large loop of pipe in order to provide the heat exchange, where heat is absorbed or rejected. This requires digging deep, wells or running large expanses of pipe horizontally in trenches in an underground reservoir. As a result, the energy efficiency benefits of a heat pump system have not been an attractive investment in urban and dense suburban environments, given the high installation costs and lack of available underground space.

Waste water often contains waste matter such as sewage, dirt, sludge, food, hazardous waste, pharmaceuticals, toys, sand, consumer articles, construction materials, manufacturing materials, biomatter, and other such detritus, which would ordinarily foul and clog a heat pump, rendering it useless. Current filtration technologies are frequently prone to clogging and blockages, oftentimes requiring manual maintenance involving shut down, opening and cleaning or replacing of filters. Accordingly, there is a need to provide self-cleaning waste water filtration devices, methods of operation, and systems suitable for continuous operation and minimal maintenance in heat pump systems. These and other needs can be met using the various inventions, and equivalents thereof; as described and claimed herein.

### SUMMARY

Provided herein are self-cleaning waste water filtration devices, comprising: a shell housing comprising one or more waste water inlets, one or more filtered thermal water outlets, one or more waste outlets, and one or more spray nozzles; a filter panel box rotatably and sealably mounted within the shell housing about an axis, the filter panel box comprising a plurality of filtration chambers, each one of the filtration chambers being fluidically isolated from the other filtration chambers, each of the filtration chambers comprising a filter capable of being contacted with pressurized waste water entering through the one or more waste water inlets when each of the filtration chambers is rotated to a waste water loading position within the shell housing, wherein each filter is capable of filtering waste water to give rise to filtered thermal water within each filtration chamber and residual waste-exterior to each filtration chamber on each filter, wherein each one of the filtration chambers and the shell housing are configured to be capable of fluidically transporting filtered thermal water through one or more filtered thermal water outlets minimize contamination by waste, waste watery or both, when each one of the filtration chambers is rotated to one or more filtered thermal water outlet positions in the shell housing, wherein each one of the filtration chambers is capable of being backwashed with backwashing water (e.g., any type of water filtered of solid matter, such as greywater, blackwater, potable water, non-potable water, ground water, rain water, lake water, river water, ocean water, stream water, and the like) entering through a backwashing inlet through the shell housing when each one of the filtration chambers is rotated to one or more backwashing positions, the spray nozzles capable of spraying spray water (e.g., any suitably filtered water as described herein can be used as spray water, such as fresh water) at each filter to assist in the removal of at least a portion of the waste from the filter when each one of the filtration chambers is rotated to one or more backwashing positions, wherein the waste outlets are configured to fluidically transport the waste, backwashing water, and spray water out of the shell housing.

Also provided herein are methods for continuously generating filtered thermal water from waste water, the method comprising: transporting pressurized waste water into a filtration device, the filtration device comprising a filter panel box capable of rotating about an axis within the filtration device, the filter panel box comprising a plurality of filtration chambers azimuthally positioned about the axis; rotating the filter panel box about the axis to give rise to one or more of the filtration chambers being in a waste water loading position to receive and filter waste water through a filter mounted on each of the one or more filtration chambers, and to give rise to at least one of the other filtration chambers being in a backwashing position; filtering the waste water through the filter to generate filtered thermal water within the one or more filtration chambers and residual waste on each of the filters; backwashing the one or more filtration chambers with backwashing water in the backwashing position; removing residual waste from the exterior surface of the filter with spray water; and discharging the backwashing water, waste and spray water.

Also described herein are systems for automatically generating heating capacity or cooling capacity from a waste water source, comprising: a heat pump; and a self-cleaning waste water filtration device for generating filtered thermal water to be used as the heating fluid source, the cooling fluid source, or both, for the heat pump, the self-cleaning waste water filtration device comprising: a shell housing comprising one or more waste water inlets, one or more filtered thermal water outlets, one or more waste outlets, and one or more spray nozzles; a filter panel box rotatably and sealably mounted within the shell housing about an axis, the filter panel box comprising a plurality of filtration chambers, each one of the filtration chambers being fluidically isolated from the other filtration chambers, each of the filtration chambers comprising a filter capable of being contacted with pressurized waste water entering through the one or more waste water inlets when each of the filtration chambers is rotated to a waste water loading position within the shell housing, wherein each filter is capable, of filtering waste water to give rise to filtered thermal water within each filtration chamber and residual waste exterior to each filtration chamber on each filter, wherein each one of the filtration chambers and the shell housing are configured to be capable of fluidically transporting filtered thermal water through one or more filtered thermal water outlets to minimize contamination by waste, waste water, or both, when each one of the filtration chambers is rotated to one or more filtered thermal water outlet positions in the shell housing, wherein each one of the filtration chambers is capable of being backwashed with backwashing water entering through a backwashing inlet through the shell housing when each one of the filtration chambers is rotated to one or more backwashing positions, the spray nozzles capable of spraying spray water at each filter to assist in the removal of at least a portion of the waste from the filter when each one of the filtration chambers is rotated to one or more backwashing positions, wherein the waste outlets are configured to fluidically transport the waste, backwashing water, and spray water out of the shell housing; and conduit capable of fluidically transmitting filtered thermal water from the one or more filtered thermal water outlets to the heat pump.

Further provided are methods for producing and transporting filtered thermal water from a waste water source to a heat pump, the filtered thermal water to be used for heating, cooling, or both, the methods comprising: transporting pressurized waste water from the waste water source into a filtration device, the filtration device comprising a filter panel box capable of rotating about an axis within the filtration device, the filter panel box comprising a plurality of filtration chambers azimuthally positioned about the axis; rotating the filter panel box about the axis to give rise to one or more; of the filtration chambers being; in a waste water loading position to receive and filter waste water through a filter mounted on each of the one or more filtration chambers, and to give rise to at least one of the other filtration chambers being in a backwashing position; filtering the waste water through the filter to generate filtered thermal water within the one or more filtration chambers and residual waste on each of the filters; backwashing the one or more filtration chambers with backwashing water in the backwashing position; removing residual waste from the exterior surface of the filter with spray water; discharging the backwashing water, waste and spray water; and transporting the filtered thermal water to the heat pump as a thermal fluid source.

The general description and the following detailed description are exemplary and explanatory only and are not restrictive of the invention as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1(a) is a cross sectional view of one embodiment of a self-cleaning waste water filtration device;

FIG. 1(b) is a cross sectional view of one embodiment of a filter panel box suitable for use in a self-cleaning waste water filtration device;

FIG. 1(c) is a sectional view of the filter panel box of FIG. 1(b) along section I-I illustrating the turning shaft of the filter panel box along the axis;

FIG. 1(d) is a 3-D view of one embodiment of a filter panel box suitable for use in a self-cleaning waste water filtration device;

FIG. 2 is a sectional view of the self-cleaning waste water filtration device of FIG 1(a) along section I-I;

FIG. 3 is a 3-D transparent view of one embodiment of the operation of a self-cleaning waste water filtration device; dashed lines illustrate the filter panel box inside the device;

FIGS. 4(a)-4(b) illustrate a series of cross-sectional views of the operation of a self-clearing waste water filtration device showing rotation of the filter box and the self-clean maintenance washing of the filters using water jets on the filter chambers of the filter box;

FIGS. 5(a)-5(f) illustrate a series of cross-sectional views of the operation of a self-cleaning waste water filtration device showing rotation of a filter box and back flushing of a filter chamber of the filter box;

FIGS. 6(a)-6(b) provide lateral and side, views, respectively of a self-cleaning waste water filtration device connected to ancillary motor arid support equipment;

FIG. 7 is a schematic representation of one embodiment of a system for automatically generating heating capacity or cooling capacity, or both, from a waste water source; and

FIG. 8 is a schematic representation of one embodiment of a system for use in a building for automatically generating heating capacity or cooling capacity, or both, from a waste water source.

### DETAILED DESCRIPTION OF ILLUSTRATIVE EMBODIMENTS

The present invention may be understood more readily by reference to the following detailed description taken in connection with the accompanying figures and examples, which form a part of this disclosure. If is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment All ranges are inclusive and combinable.

It is to be appreciated that certain features of the invention which are, for clarity, described herein in the context of separate embodiments, may also be provided in combination in a single embodiment. Conversely, various, features of the invention that are, for brevity, described in. the context of a single embodiments may also be provided separately or in any subcombination. Further, reference to values stated in ranges includes each arid every value within that range.

Terms

As used herein, the term “dirt” refers to any solid-like or mud-like substance comprising biomatter, sand, or both.

As used herein, the term “biomatter” includes any animal, organism or microorganism, or part thereof, or any substance produced, excreted, or eliminated by any animal, organism or microorganism, or part thereof.

As used herein, the terms “waste water” and “wastewater” refer to any water, whether found in the environment or processed by human activity, which water may comprise particulates, solid matter, dirt, or any combination thereof.

Self-cleaning waste water filtration devices as provided herein include a number of inter-operating components on an exterior shell housing that make up the exterior of the device for making suitable plumbing connections and the like, such as one or more waste water inlets, one or more filtered thermal water outlets, one or more waste outlets, and one or more spray nozzles. The shell housing may be of any suitable shape for meeting the requirements as set forth herein, and is typically cylindrical. One inner side surface of the shell housing comprises the filtered thermal water outlets and backwashing inlets. A second inner side surface; of the shell housing can comprise an axle therethrough for rotating a filter panel box residing within the shell housing. The filter panel box is rotatable about an axis that is congruent to the inner side surfaces of the shell housing. The filter panel box is sealably mounted within the shell housing to permit the collecting and discharging of waste from the waste water source before, during, or after rotation.

Suitable filter panel boxes comprise a plurality of filtration chambers, each one of the filtration chambers being fluidically isolated from the other filtration chambers. The filter panel box may comprise from three to sixteen filtration chambers, preferably, from four to twelve filtration chambers, and most preferably four filtration chambers. The filtration chambers are typically azimuthally oriented around the axis of the filter panel box. The outer (i.e., filter) surfaces of the filter panel boxes typically forms a regular polygon (triangle, square, pentagon, hexagon, septagon, octagon, nonagon, decagon, undecagon, dodecagon, and the like) when viewed from the direction of the axis. Each one of the filtration chambers is generally sealed except for the filters that allow the passage of filtered thermal water (i.e., filtered gray water from showers and sinks, or filtered black water containing fecal matter) from the waste water source into the interior of the filtration chambers, and a fluidic passage (“side opening”) that permits the fluidic transport of filtered thermal water directly out of the filtration chamber or backwashing water directly into the filtration chamber. The filter panel boxes are sealably mounted within the shell housing to permit the adjoining vertices of adjacent filtration chambers to touch the interior of the shell thereby maintaining a fluidic seal while also permitting rotation of the filter box. An area capable of holding waste water is formed between the adjoining vertices of adjacent filtration chambers having the filter disposed therebetween and then inner surface of the shell housing disposed directly opposite to the filter. This area rotates with the filter box to allow the filtration chamber corresponding to the filter to be filled with waste water and to rotate the waste on the filter to a suitable discharge outlet.

The filters on each of the filtration chambers generally comprise a porous surface such as a membrane, wire mesh screen, woven metal, screen made of any of a variety of durable materials such as metal, plastic, ceramic, glass, as well as any combinations of these. For sewage applications the filter is preferably composed of a metal screen made of sheet metal with a plurality of holes. Each of the filters on each of the filtration chambers are capable of being contacted with pressurized waste water using suitable electric pumps as described in further detail herein.

During operation, water enters the filtration device through, a waste water inlet when one of the filtration chambers is rotated with the filter box around the axis of the filter box. Each of the filtration chambers, in turn, are rotted to a waste water loading position within the shell housing. Each filter, in turn, then filters the waste water to give rise to filtered thermal water within its corresponding filtration chamber and residual waste deposited on the each filter (“exterior to each filtration chamber on each filter”).

Each one of the filtration chambers and the shell housing are configured to be capable of fluidically transporting filtered thermal water through one or more filtered thermal water outlets to minimize contamination by waste, waste water, or both, when each one of the filtration chambers is rotated to one or more filtered thermal water outlet positions in the shell housing. Each one of the filtration chambers is capable of being backwashed with backwashing water entering through a backwashing inlet through the shell housing. Backwashing water from the backwashing inlet enters the filter chamber at an opening on a side of the filter chamber when that opening is aligned with the backwashing inlet of the shell housing. Typically the opening is at least several inches in diameter and is preferably circular. Preferably the filtration chambers are oriented so that all of the openings of each of the sides are on the same side of the filter box. Each of the openings may further have a slidable sealing material, such as an o-ring, for forming a fluidic seal directly adjacent to an inner side surface of the shell housing that have the filtered thermal water outlets and backwashing inlets.

The filtration device further comprises at least one backwashing position (i.e., a filter cleaning position) at which one of the filtration chambers is rotated to for cleaning. In this position are located one or more spray nozzles that are positioned for spraying spraywater at the waste on the surface of the filter to assist in the removal of at least a portion of the waste from the filter. Also at this backwashing position is the backwashing water inlet for pumping water into the filter chamber to help flush waste out of the filter and into the area between the filter surface and the shell housing. One or more waste outlets are typically positioned on the shell chamber at the backwashing position so as to fluidically transport the waste, backwashing water, and spray water out of the shell housing.

Method for continuously generating filtered thermal water from waste water are also provided. These methods include transporting pressurized waste water into the filtration device and rotating the filter panel box about the axis to give rise to one or more of the filtration chambers being in a waste water loading position to receive and filter wastewater through the filter mounted on each of the one or more filtration chambers. This rotation of the filter panel box also gives rise to at least one of the other filtration chambers being in the backwashing position.

Filtering the waste water through the filter generates filtered thermal water within the one or more filtration chambers and residual waste on each of the filters. Over time the filters become clogged with the waste matter and requires cleaning. The filters can be s cleaned using pressurized backwashing water for pushing waste material out of the filter. Backwashing water can comprise any relatively waster source that has been at least filtered to remove solid matter that would otherwise clog the filter. Suitable sources of backwashing water include filtered thermal water and clean water. The filtered thermal water can originate from the filter device directly, or indirectly by filtered thermal water being returned from a heat transfer device such as a heat pump.

Backwashing typically occurs when one or more filtration chambers are in the backwashing position. Pressurized backwashing water is pumped into the backwashing inlet using a suitable pumping device such as an electric pump. In at least one embodiment, two of the filtration chambers are adjacent to each other and positioned in the waste water loading position, while a third filtration chamber is positioned in the backwashing position. Simultaneously, or before or after backwashing residual waste is removed from the exterior surface of the filter with pressurized spray water exiting from the nozzles. The backwashing water, waste and spray water are simultaneously or subsequently discharged through a suitable waste outlet.

During operation of the filter device for continuously generating filtered thermal water from waste water, a pressure discharge can be used for reducing mixing between the water from the chamber in the backwashing chamber position when it is moved to the waste water inlet position. The pressure discharge reduces water pressure to minimize backwash water from one chamber crossing over and getting into the area of the waste water inlet. The pressure discharge also reduces pressure in the chamber with pressure discharge so that this chamber can be in good working condition when it turns into the waste water inlet/filtering position. Accordingly, an additional step can be used to reduce pressure in a filtration chamber prior to rotating that filtration chamber into the waste water loading position.

As the filter device is operated, the filter panel box can rotated continuously or discontinuously. If discontinuously, then the filter panel box can be rotated up to 180 degrees, or up to 120 degrees, or up to 90 degrees, or up to 60 degrees, or up to 45 degrees before stopping. Any number of degrees can be used, and is typically determined as a multiple of the number equal to 360 degrees divided by the number of filtration chambers azimuthally positioned about the axis.

When generating filtered thermal water from waste water, the filter panel box may have two ends orthogonal to the axis, one of the two ends being fluidically sealed, and the other end transporting filtered thermal water out of the one or more filtration chambers in the waste water loading position. The end transporting the filtered thermal water allows the filtered thermal water to flow in or out of the chamber, depending on which position it is in (i.e., waste water inlet or waste outlet). Accordingly, each of the filtration chambers has a hole directed to one side of the filter panel box. The holes are preferably oriented in the same direction towards the same set of outlets and vents. In other embodiments, the other end also transports backwashing water into the one or more filtration chambers in the backwashing position. As the filter panel box rotates inside the shell housing, the positions of the holes match the positions of the filtered thermal water outlet and inlet on the shell. The outer surface of the filter box and inside surface of shell is very close, which is helps reduce water mixing efficiently in this part of the device.

Systems for automatically generating heating capacity or cooling capacity from a waste water source are also provided. These systems include a waste water source, a self-cleaning waste water filtration device for generating filtered thermal water as described herein, one or more heat pumps, and conduit capable of fluidically transmit water from the one or more filtered thermal water outlets to the heat pump. The preferred systems are configured so that at least a portion of the filtered thermal water exiting the heat pump is used as the backwashing water in the self-cleaning wastewater filtration device. Suitable wastewater sources comprise raw sewage, sewage that is at least partially processed, industrial waste, process cooling water, river water, ground water, rain water, lake water, ocean water, shale processing frac water, or any combination thereof. The systems can actually use almost any type of fluid medium, whether gas, liquid, of super critical fluid. Almost any type of liquid may be used, as long as the fluid is not very sticky and a fluid is used without too much sand articles or too heavy large articles.

Methods for producing and transporting filtered thermal water from a waste water source to a heat pump are also provided in which the filtered thermal water can be used for heating, cooling, or both. In these methods the filtered thermal water is generated by transporting pressurized waste water from the waste water source into a self-cleaning waste water filtration device as described herein. The filtered thermal water is then transported to a heat pump to be used as a thermal fluid source for use in cooling or heating, depending on the relative temperature of the thermal fluid source to that of the environment. For example, during the winter the environment may be an air temperature of 0 degrees C. and a municipal potable water supply temperature of 5 degrees C. If the waste water is sewage at 20 degrees C., then the waste water can be used for transporting heat to the cold air and water. Likewise, during the summer the environment may be an air temperature of 33 degrees C. If the waste water is sewage at 20 degrees C., then the waste water can be used for transporting heat away from the warmer air.

To ensure smooth continual operation, it is desirable to provide and constant source of waste water. Occasionally the waste water source may run low or stop due to inactivity. In this situation the systems may be continuously operated by further providing that the waste water source at least partially fills a holding tank. Waste water is then directly taken from the holding tank which can be large enough to provide a waste water source during the periods of inactivity. This will help ensure safe, continual, operation of the system. An example for use in city buildings is that a sewage holding tank is placed upstream and convenient to the building. This building, e.g., the basement can be used for housing the self-cleaning waste water filtration device. In this, example the waste water source comprises a sewage line and the waste water comprises sewage. Accordingly, the preferred systems will incorporate and use holding tank for stable sewage condition.

### EXAMPLES AND OTHER ILLUSTRATIVE EMBODIMENTS

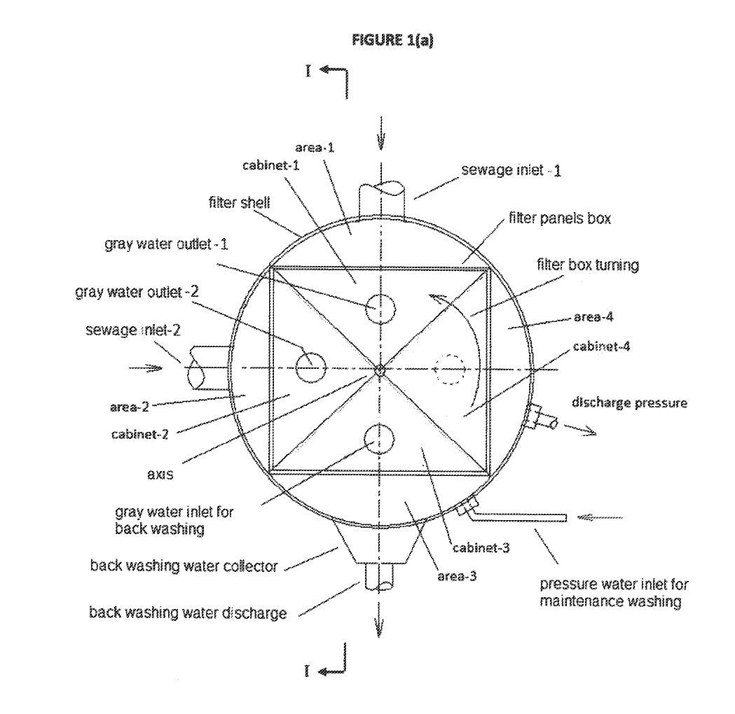

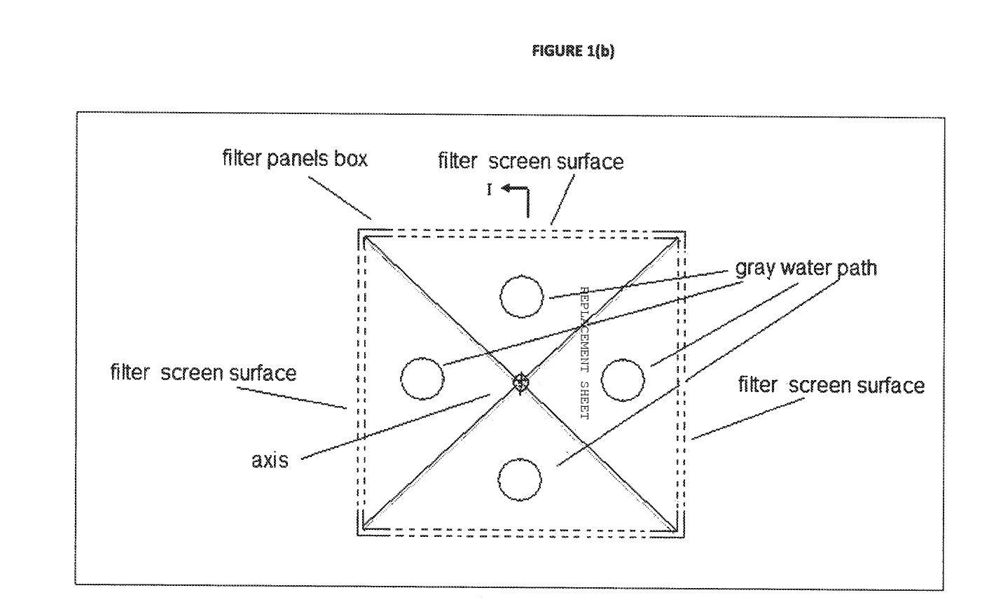

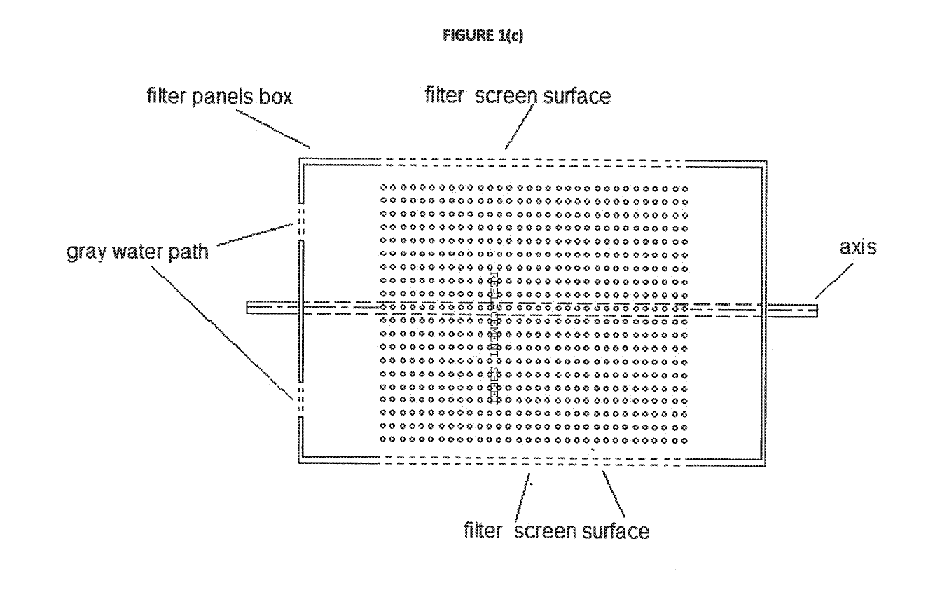

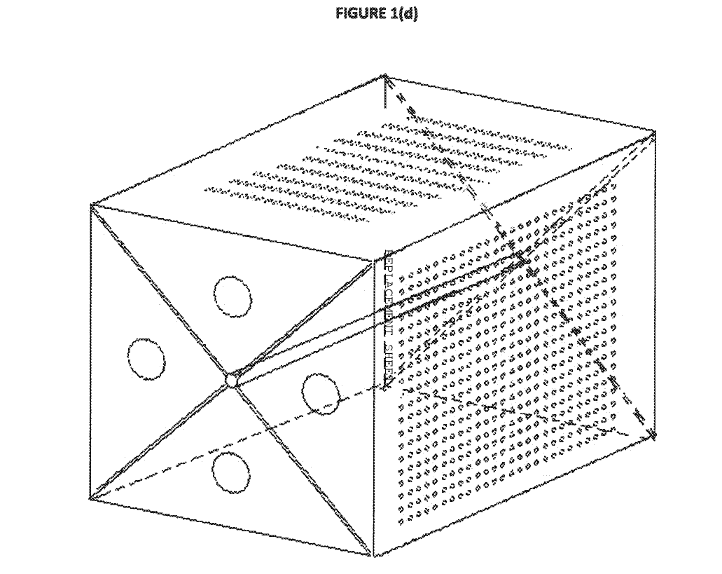

FIG. 1(a) is a cross sectional-view of a self-cleaning wastewater filtration device. A filter function is to separate dirt from fluid. In the sewage, source energy conversion system, such as a system for automatically generating hearing capacity or cooling capacity from a waste water source, the filter device functions as a dirt separator and also prevents mixing or the various water process streams to avoid thermal contamination, e.g., cold spray water mixing with and codling the filtered thermal water stream, or the cooler backwashing filtered thermal Water returning from the heat pump mixing with freshly filtered warm filtered thermal water about to be fluidically transmitted to the heat pump, and so on. Accordingly, such mixing of warmer and cooler fluid streams (“the water mixing problem”) will reduce energy conversion efficiency.

Referring to FIG. 1(a), there are several features of the self-cleaning waste water filtration device that overcome the water mixing problem. First, the waste water inlet residing on top of the filtration device helps to prevent incoming waste water and outgoing backwash fluid mixing because the two regions are not adjacent to each other. Keeping waste water inlet and the backwash inlet at distances to helps to increase the hydraulic distance between cabinet 3 (filtration chamber 3) and area 1 (area adjacent to a waste water inlet) so that fluid pressure of incoming sewage (waste water) in area 1 and backwash water in backwashing area, cabinet 3 do not affect each other. This will help reduce mixing water between these two regions.

A second feature helps to overcome the water mixing problem, which is to completely closed-off one end of the filter panel box to fluid flow, and to maintain substantially closed-off end on the opposite side comprising only sufficiently small openings (e.g., round holes) to allow for filtered thermal water passage through the shell housing as shown in FIGS. 1(a) to 1(d). Filtered thermal water exits to the heat pump, and returns from heat pump for backwashing. The design of the closed end and substantially closed opposite end substantially reduces fluid mixing. By using closed end with four circle holes on the other end, the hydraulic distance increased a lot between each cabinet behind of each holes and areas between the filter panel box and the inner shell housing. Also the gap between end wall of filter screen box and shell of the device is very small. These will increase the hydraulic resistance for the fluid, between cabinet behind of each hole. These features aid to reduce water mixing and thereby increases energy efficiency.

FIGS. 1(b) to 1(d) illustrates several views of a suitable filter panel box comprising four filter chambers azimuthally oriented around the axis. This can also be referred to as an azimuthally segmented polygonal filter panel box wherein each of the segments comprises a filtration chamber as described herein. These figures illustrate the orientation and position of the four filter chambers, the filters on the outside of each filtration chamber, the lack of fluid flow directly between the filtration chambers, and the filtered thermal water openings. FIG. 1(b) depicts the side of the filter panel box having the ray water openings; the opposite end is fully closed. FIG. 1(c) illustrates the a sectional view of the filter panel box showing the filtered thermal water openings on the left side of the filter panel box, and sealed on the right side. The filter is depicted as a substrate with a plurality of small holes therein. FIG. 1(d) illustrates a 3-D view of the filter panel box with a closed end and a four-opening end (one opening per chamber).

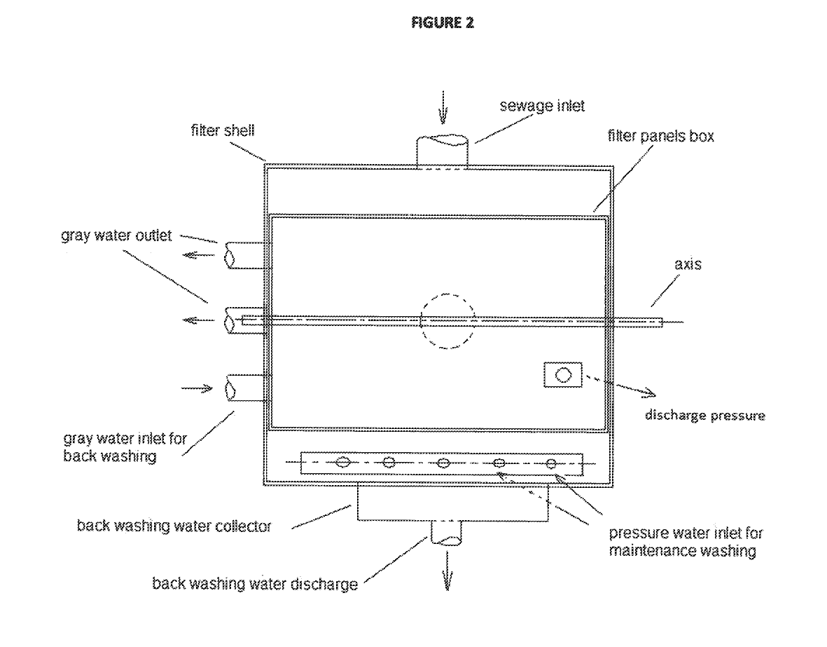

FIG. 2 is a sectional view of the self-cleaning waste water filtration device of FIG 1(a) along section I-I. An put let of discharge pressure is added in order to reduce water mix cause by high pressure. This does not exist in previous design

2. A set of spring nozzles and pressure water inlet for maintenance washing are added at bottom of the filter shell. This is a very importance part for the device self-clean. Previous design does not have this part.

3. Spray clear water will fully clean the filter surface for a few minutes after filtering function stop. When the pressured clean water is spraying the filter screen panel box will be turning. The filter surfaces will be cleaned one by one many times in many turns during the self-clean processing. This will effectively prevent the filter surface from blockage by remaining dirt on the surface after device stop filtering. After filtering surfaces have fully cleaned, the pressured spray water will stop and the filter device will be turn off.

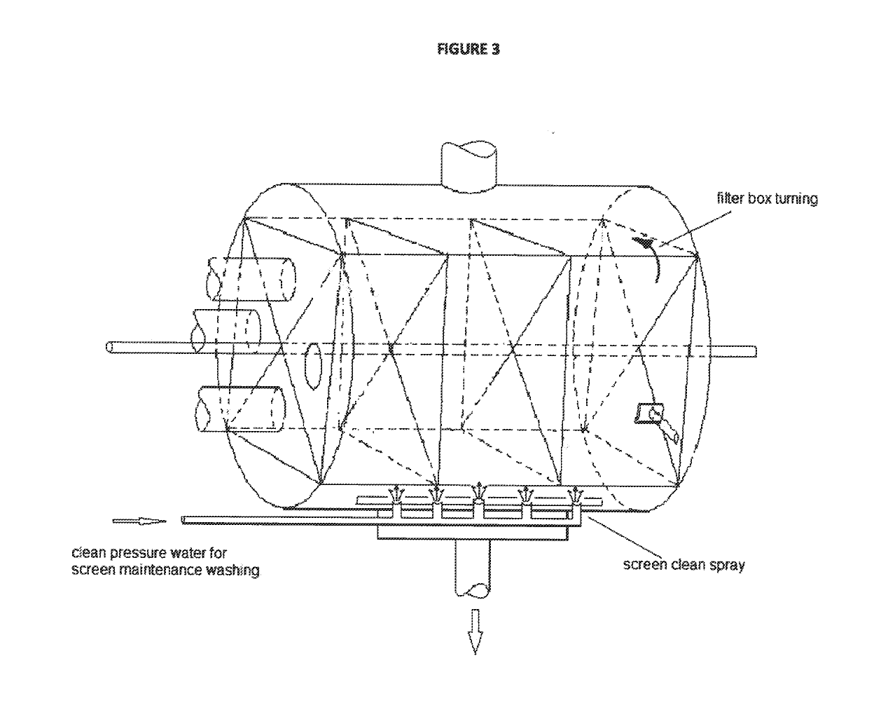

FIG. 3 is a 3-D transparent view of one embodiment of the operation of a self-cleaning waste water filtration device of FIG. 2. The dashed lines illustrate the filter panel box and other internal structures inside the device. This drawing illustrates the orientation of a plurality of spray nozzles and clean water spraying through the spray nozzles towards a filter positioned at the backwash/cleaning position at 6 o'clock.

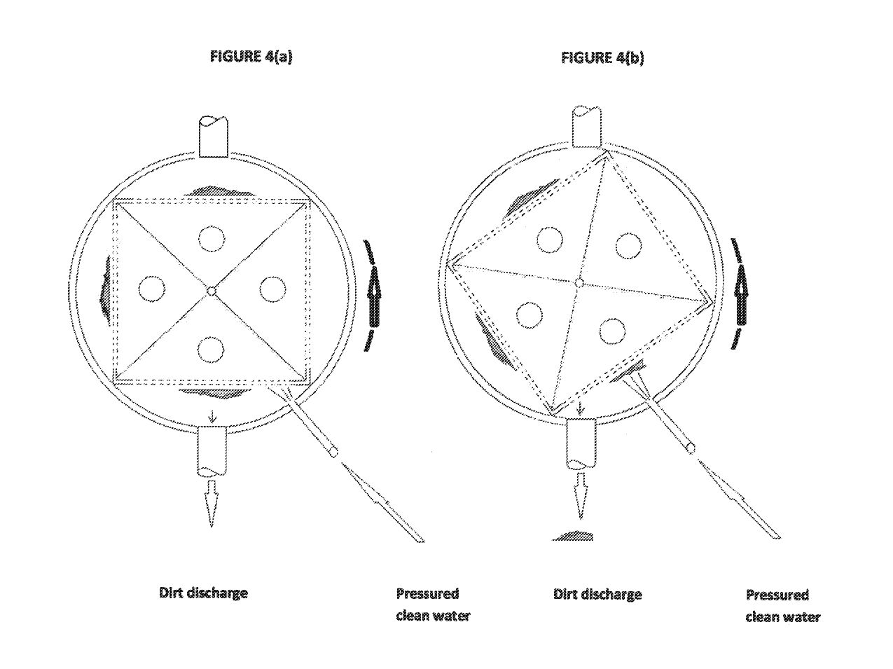

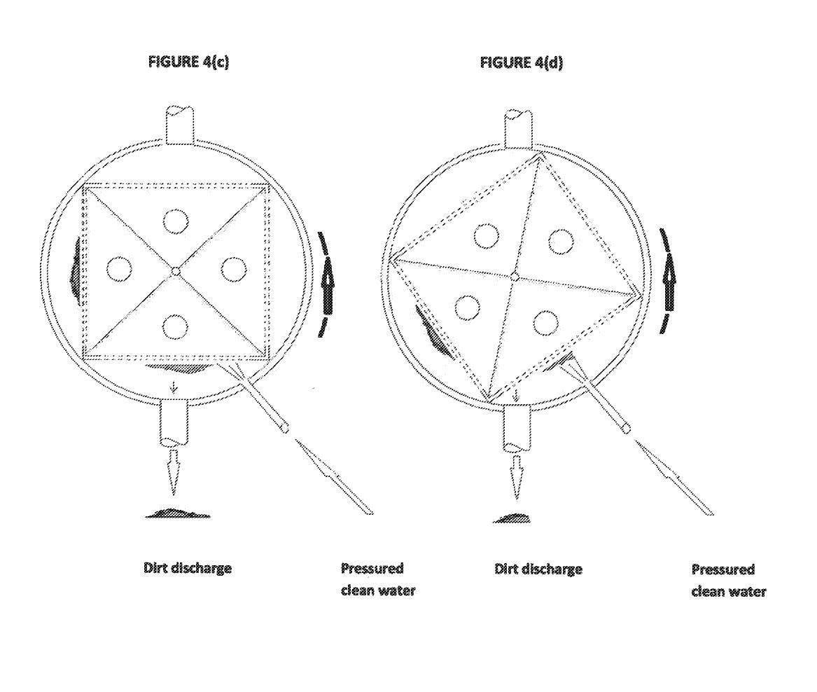

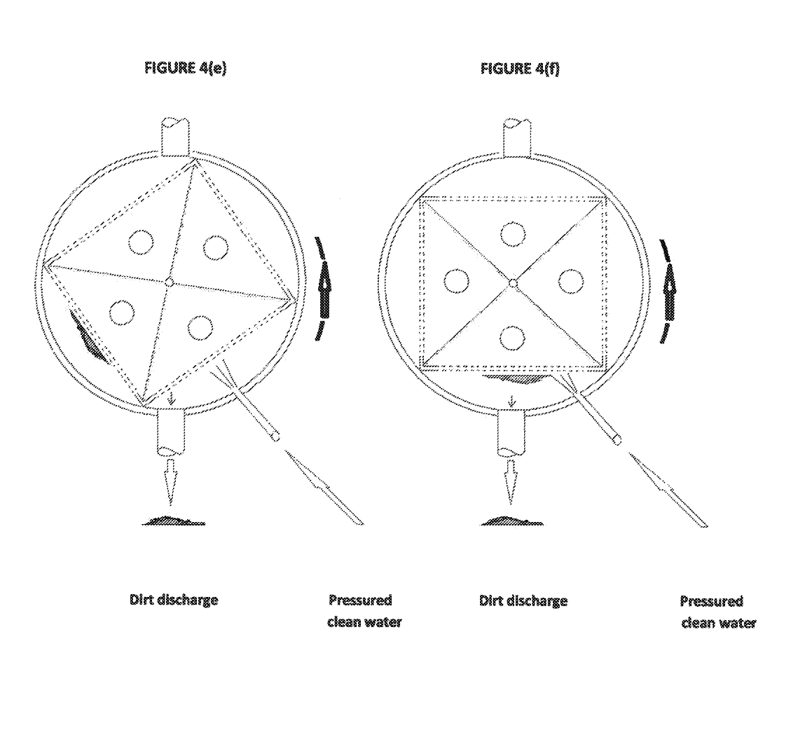

FIGS. 4(a) through 4(h) illustrate a series of cross-sectional views of the operation of a self-cleaning waste water filtration device showing rotation of the filter box and the self-clean maintenance, washing of the filters using waterjets on the filter chambers of the filter box. These figures illustrate the filter surface self-clean mechanism by pressurized clean water spraying clean the filters as the filter panel box rotates through the cleaning cycle. The self-clean could be controlled automatically by system control center or manually.

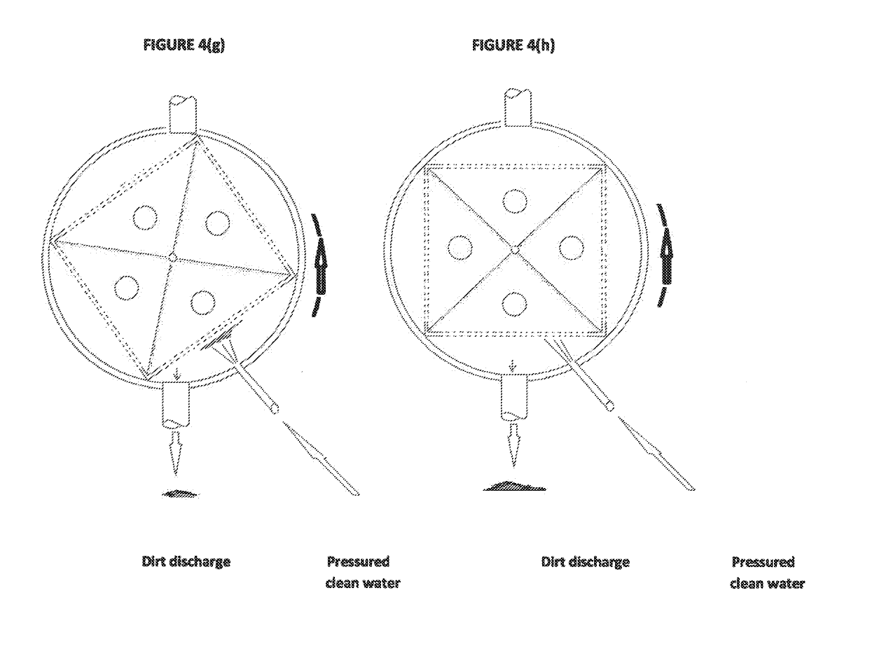

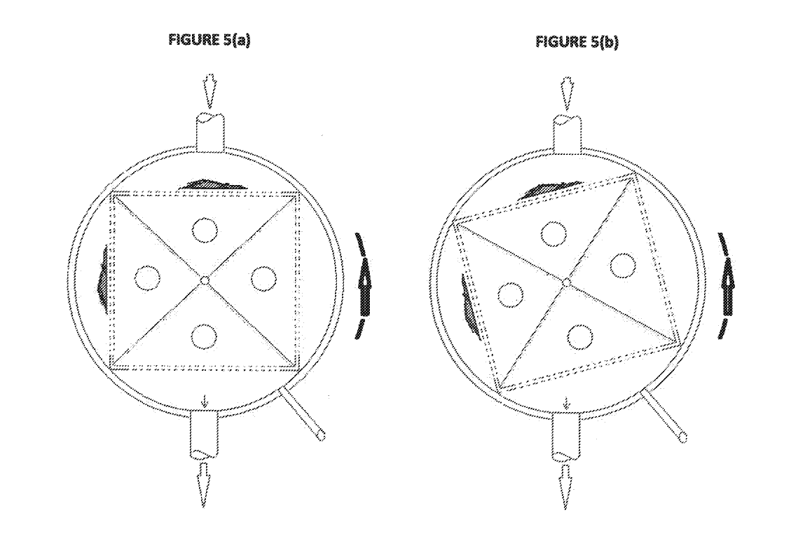

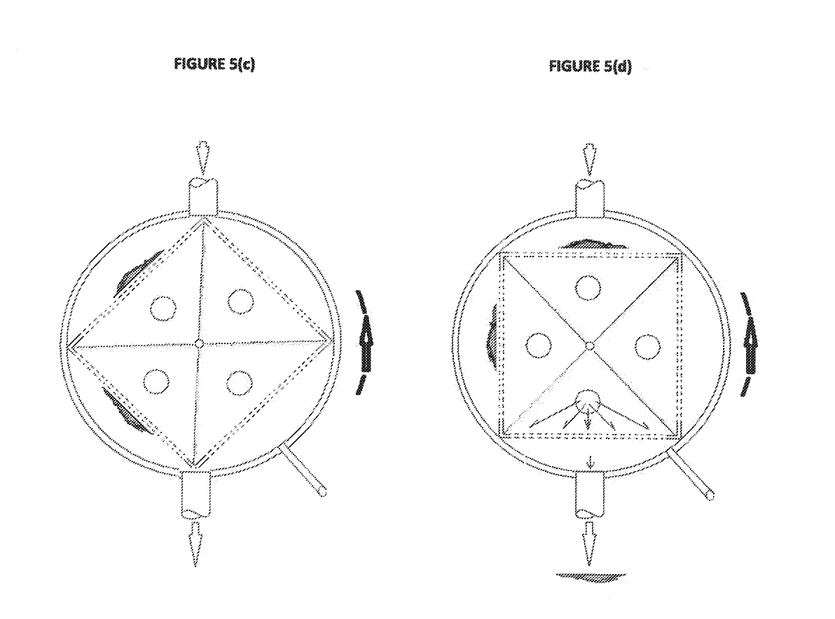

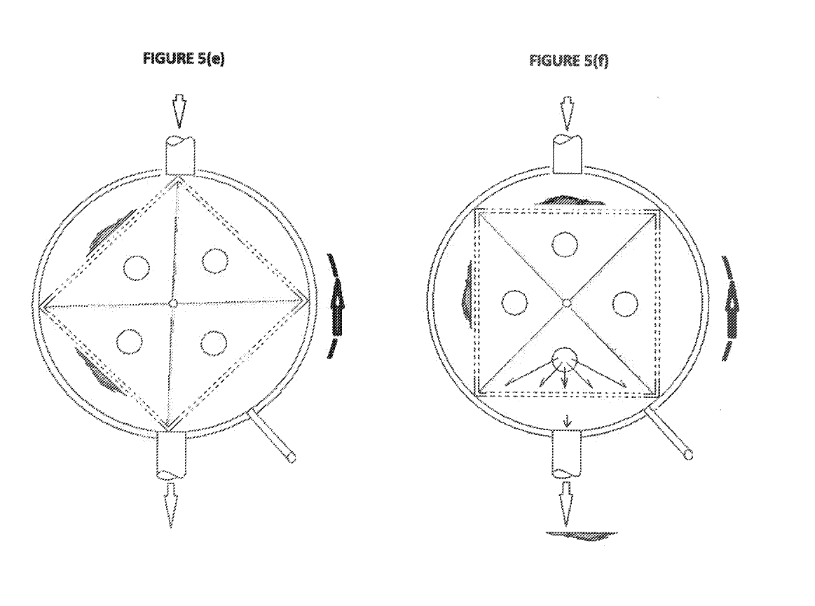

FIGS. 5(a) through 5(f) illustrates a series of cross-sectional views of the operation of a self-cleaning waste water filtration device showing rotation of a filter panel box and back flushing of a filter of a filtration chamber of the filter box. FIG. 5(a) illustrates an a filter panel box having waste on two filters (at the 12 o'clock position, corresponding to one waste water loading position of this example) and at the 9 o'clock position. The filter panel box at the 6 o'clock position is currently clean because of the initial startup condition. The filter panel box continues to turn, showing the result after rotating a total of 15 degrees counterclockwise in FIG. 5(b) and a total of 45 degrees counterclockwise in FIG; 5(c). In FIG. 5(d), the filter panel box has rotated a total of 90 degrees. More waste water flows into die top waste water inlet and waste deposits on the filter of the filtration chamber in the waste water loading position at the 12 o'clock position. Arrows emanating from the opening in the filtration chamber in the backwashing position illustrate backwashing water entering that filtration chamber from the backwash inlet (not shown) to backwash the filter and cause the waste to flow off of the filter and down and discharged through me waste outlet. FIG. 5(e) now shows the filter panel box having rotated a total of 135 degrees counterclockwise. In FIG. 5(f), the filter panel box has rotated a total of 180 degrees. The situation is the same as when the filter panel box had rotated a total of 90 degrees: more waste water flows into the top waste water inlet and waste deposits on the filter of the filtration chamber in the waste water loading position at the 12 o'clock position. Arrows emanating from the opening in the filtration chamber in the backwashing position illustrate backwashing water entering that filtration chamber from the backwash inlet (not shown) to backwash the filter and cause the waste to flow off of the filter and down and discharged through the waste outlet.

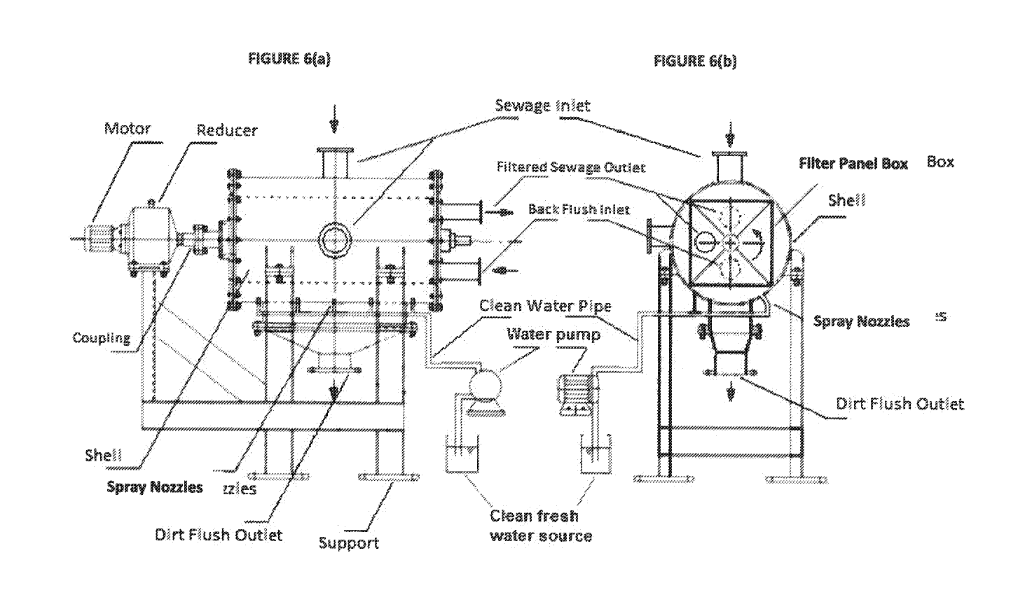

Referring to FIGS. 6(a) and 6(b), there is provided lateral and side views, respectively of a self-cleaning waste water filtration device connected to ancillary motor and reducer gear and coupling for rotating the filter panel box inside the filtration device. Some additional support equipment and water pump are also illustrated.

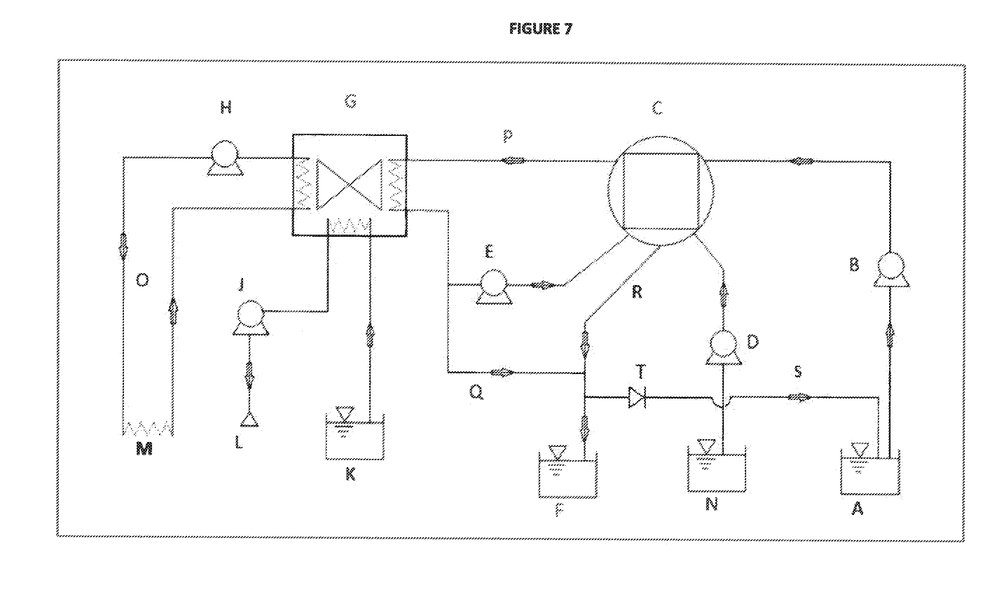

Referring to FIG. 7, there is provided a schematic representation of one embodiment of a system using a sewage source for automatically generating heating capacity or cooling capacity for use in a building. This example utilizes the following components:

A: City Sewage Pipe (i.e., waste water source, upstream) and Sewage Source Holding Tank (i.e., holding tank)

B: Sewage Pumps

G: Self Clean and Automatic Fluid Filtering Device for Waste Water Treatment and Fluid Separation (i.e., a self-cleaning waste water filtration device)

D: Clean Water Pump

E: Sewage Back Flush Pump

F: City Sewage Pipe (i.e., waste water source, downstream)

G: Anti-filth Sewage Source Heat Pump with Refrigerant Media Switching (i.e., a heat pump)

H: Heating and Cooling Clean Water Circulation Pump

J: Clean Water Pump

K: Clean Fresh Water Source

L: Usage End of Hot or Chill Water

M: Heating and Cooling Deliver Device

N: Clean Fresh Water Source

O: Clean Water Circulation Pipe

P: Filtered Sewage Pipe

Q: Filtered Sewage Return Pipe

R: Back Flush Sewage Return Pipe

S: Filtered Sewage Return Pipe to Sewage Source Holding Tank A

T: Sewage Flow Redirect Control Valve

Heating Mode Example. The system takes sewage from city sewer main A with temperature 50˜60 F. degree by using sewage pump B and pumps it into the self-cleaning waste water filtration device C. The filtered sewage is pumped into heat pump G through pipe P by the power of pump B and transfers heat from sewage to clean circulated water in the loop O, on the other side of heat pump, powered by a circulation pump H. The filtered sewage (filtered thermal water) temperature reduces about 10˜15 F. degree after heat is transferred. to clean water in the loop O.

While heat is being transferred, a part of the filtered thermal water can be pumped to city sewer main F, downstream of the spot A, through pipe Q, another part of the filtered thermal water is pumped by pump E, with higher pressure, into filtration device C to backwash and clean the filter screen from inside the filtration chamber. Simultaneously clean water from source N is pumped using pump D for use in the spray nozzles to jet water against the outer surface of the filter screen to loosen and wash away the sewage matter (dirt). The backwashing process helps to take dirt away from the filter surface and is discharged into city sewer main F through pipe R.

In this example, the circulated clean water gain heat and its temperature increases about 10˜15 degrees F., from 105 degrees F. to 115˜120 degrees F. The highest temperature that clean water can reach is about 150 degrees F. in the heating mode.

Cooling Mode Example. The system takes sewage from city sewer main A with temperature 75˜85 F. degree. By the heat transferring, the heat pump will make clean circulation water temperature as low as 40 F. degree from 55˜60 F. degree. Normally, the temperature of clean circulation water could be changed 55 F. degree to 45 F. degree.

Domestic Hot Water Example. The heat pump can also heat domestic water for use in sink faucets, laundry machines, washing-machines, or bathtub or shower. In summer season domestic water could be further heated from heated water from the building's cooling system. Thus, additional heat can be generated by the cooling cycle to heat a building's clean domestic hot water. That is, instead of putting the heat generated as a byproduct of the cooling cycle back into the municipal sewer loop, it can be harnessed by the building's domestic hot water loop using the systems described herein. This is particularly valuable for buildings with heavy hot water loads such as hotel, hospitals and laboratories.

Sewage Requirements. A typical sewage requirement for building heating and cooling is about 500 to 600 gallons of sewage per minute per 100,000. square feet of building (500˜600 GPM/100,000 Sq ft).

Safety Considerations. Referring to FIG. 7, Sewage Source Holding Tank A is connected to the city sewer main. The tank size is required with 10˜20 minutes of sewage required capacity in order for system to run under stable conditions to maintain a consistently stable waste water sewage level and flow rate.

Filtered sewage water (filtered blackwater) returns to city sewage pipe F after heat exchange in heat pump G through the return pipe Q. When the sewage source is inadequate (i.e., shortage) over a very short period, the returning filtered thermal water can be redirected via valve T to sewage source tank A so that returning filtered thermal water S can be reused to provide enough waste water (sewage) flow into the system. If the waste water shortage lasts too long, then me returning filtered thermal water (i.e., reused blackwater) temperature will become unsuitable as heating or cooling source, and the heat pump can be programmed .to automatically shut down. Filtered thermal water redirecting can be controlled by a suitable sewage level monitoring device in the holding tank and sewage redirect control valving T in the system. This will help overcome problems associated with system shutdown in the event of a sewage shortage. Hence, filtered thermal water redirecting back to the holding tank will help make the system operate stably and prevent shutdowns.

During operation of one embodiment of the system for automatically generating heating capacity or cooling capacity from a sewage source, the system Can readily use from 20% to about 50% of the sewage main base flow. Sewage flow may not be very stable in the event that the system does not use the total flow in the sewer main. Occasionally there may be a very short period without enough sewage flow. Accordingly, in some embodiments as a first safety feature, a holding tank is provided that is capable of keeping about 10 minutes-equivalent of system required sewage volume as a first protection. If the sewage shortage period lasts longer than about 10 minutes then, as a second safety feature, the system can be plumbed and programmed to reuse the filtered thermal water exiting the heat pump directly into the waste Water inlet. This will help to overcome another 20 minute waste water (sewage) shortage. Both are used to keep consistent sewage flow rate. The inclusion of these two safety features helps to ensure that the system has a stable waste water source for continual Operation. If sewage shortage happens and both protections fail, heat pump unit protection system will shut down the unit.

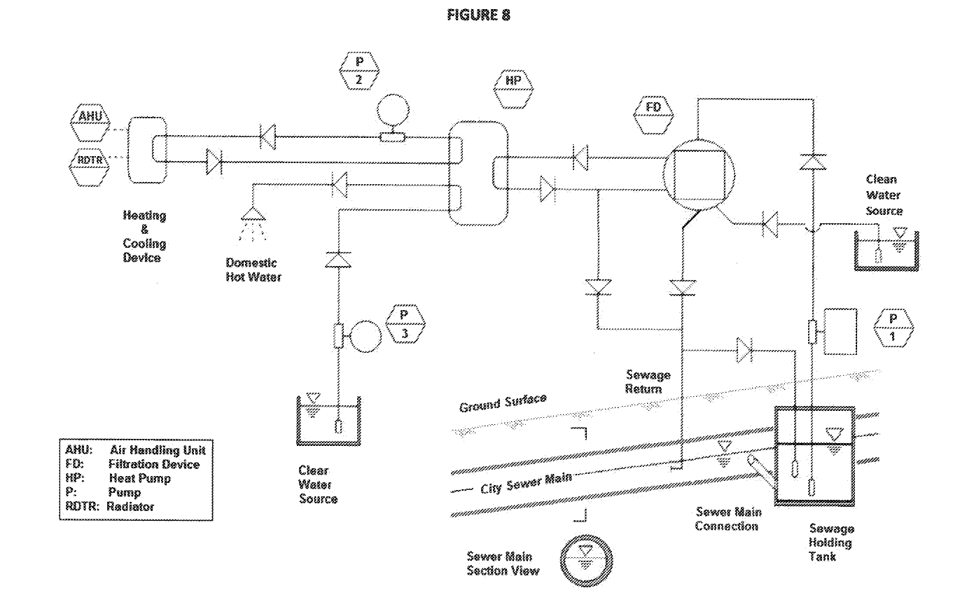

Systems, devices and methods for building energy efficient infrastructure for directly using city waste water (i.e., sewage) in heating and cooling systems of buildings has been described. Continuous and self-cleaning waste water filtering enables the use of sewage in the disclosed systems. A heat pump converts low degree level energy in sewage to high level degree energy so that high degree level energy, can be used in cooling and heating of buildings. A heat exchange unit is not required between the continuous waste water filtration device and the heat pump. The disclosed systems effectively increases the heat exchange efficiency and reduces maintenance costs. These systems can be conveniently installed and used in city buildings and can be installed at any location with any size. The/disclosed systems do not necessarily require infrastructure changes in city sewage system. The disclosed systems essentially only require a pipe connection to a sewage pipe to take and return sewage. A suitable system based on using sewage as the waste water is depicted in FIG. 8, which is a schematic representation of an embodiment of a system for use in a building for automatically generating heating capacity or cooling capacity, or both, from a city sewer main.

Because of these systems, devices and methods, sewage black water and other forms of filtered waste water can be transmitted directly to a heat pump and the whole system can be automatically operated with little to no maintenance.

Operating Parameters for Waste Water Heating/Cooling Recovery System of FIG. 7 based on City Sewage. City sewage temperatures are generally above 60 F. degrees (15 C. degrees) in winter and below 77 F. degrees (25 C. degrees) in summer. Hence, city sewage is a good energy source for the Sewage Source Heat Pump (G).

During sewage goes through the Sewage Source Heat Pump (G), the Sewage Source Heat Pump (G) will convert energy from sewage to clean water on the other side of Sewage Source Heat Pump COP value equals to 4˜6. There is no connection between sewage and clean wafer.

After clean water receives either heat energy or cool energy, the clean water temperature could reach to as high as 113˜150 F. degree (45-65 C. degree) for buildings heating or as low as 41-45 F. degree (5-7 C. degree) for buildings cooling. The clean water circulation pump (H) circulates clean water in the circulation pipe (O) in buildings.

Clean water will release; either heat energy or cool energy at energy deliver device (M).

Another clean water section can be ah open-end section. Water from clean water source (K) can go through the Sewage Source Heat Pump (G) and receive energy converted from sewage. The Sewage Source Heat Pump could make either hot water at 113˜140 F. degree (45˜60 C. degree) or cold water at 41˜45 F. degree (5˜7 C. degree) depends on needs. The either hot water or chill water can be used at usage end (L).

The Sewage Source Heat Pump (G) can switch refrigerant media direction in the Sewage Source Heat Pump (G) internally according to heating and cooling needed.

After energy converting from filtered sewage to clean water, clean water receives heating or cooling energy, and filtered sewage temperature increases or reduces, 6˜20 degrees F. (3˜10 degrees C.).

On the sewage side, the system brings in sewage from city sewage pipe line and discharge sewage back to sewage pipe line. At clean waterside, the system circulates clean water for building heating and cooling, or produce hot water or chill water for other uses.

Sewage temperature changing range after going through this system is about 6˜20 degrees F. (3˜10 degrees C.).

Automatic, continually functioning waste water filtration devices have distinct advantages over manually-cleaned filtration devices. For example, when the filtration device stops filtering, it also stops the back washing, which causes remaining dirt and filth material to stay and attach at the surfaces of filter panels. When the filter device becomes dry, those attached material will be dry on the filter panel surfaces and that will become blockage because the organic material in the dirt may have strong sticky function. When the filter device starts to work again, the filter panel surfaces cannot perform filter function well because a large/fraction of the filter area is blocked by this dirt material from sewage. Backwash water generally cannot remove this kind of blockage. At this situation, manual maintenance is generally required. Not only are the manual maintenance costs high and very time consuming, but also this problem makes automatic filtering device impossible to be a fully automatic.

A group of water nozzles is constructed inside of the filter device. The nozzles are fixed on the wall of filter shell, closed to the bottom of the shell. The head of each nozzle is on the same surface of inner wall of filter device shell. The nozzles are arranged in a line with certain distance between each other. It is preferred that the nozzles are aligned so that the spray water can wash the entire filter panel face.

Washing water pressure, nozzles location and set up angle can be suitably adjusted for to increase filter cleaning performance. A washing pump is connected to a clean fresh water source. Pump sends clean water to distributed nozzles through the clean water pipe. In one embodiment, when the filtering device stops filtering work, the washing pump starts to work. The clean fresh water goes through distributed nozzles and springs out to fully wash each filter panel surface. It removes remained dirt and filth on the filter panel surface.

The filter surface washing pump, is controlled by an auto-control system. When the main system stops filtering work and sewage supplying stops, then the control system sends a signal to start the washing pump. Fresh clean water will be pumped through washing pipes to distributed nozzles located at the side wall near the bottom of filtering device to wash the filter surfaces. During the washing, the filtering control system will slowly turn the filter panel box so that every surface of filter panels can be fully washed and cleaned one by one. Washing process will last long enough to ensure, that there is no dirt and filth material left on the surfaces of filter panels. The washing water will be discharged into sewage pipe line.

This devices, methods and systems provided herein overcome the disadvantage of current systems and significantly increases the filter device efficiency and automatic operation. It makes the filter device essentially maintenance free, reducing cost of maintenance and effectively reducing the time in maintenances of the filtering device.

For industrial applications, industries that produce and use heat as a part of their processes should be able to utilize the inventions described herein. In addition to harvesting the heat from wastewater, heat from industrial water can be harvested for use elsewhere or back in the process. While the water temperature range delivered by the heating systems described herein is typically in the range of from about 40 degrees F. to a maximum of about 150 degrees F., higher temperatures can be achieved by further heating using traditional means.

Furthermore, multiple heat pumps, one or more filtration units, of any combination thereof, can be installed in view of the modularity of the filtration technology described herein. Hence, systems comprising a plurality of heat-pumps, and one or more of the filtration units described herein are readily scalable for buildings comprising from about 20,000 square, feet (“SF”) up to several million SF. Installation of such systems can be for a single building of in a central plant serving multiple buildings. Utility scale application is also possible, where a utility owns and operates and utilizes flexibly among multiple buildings to manage peak demand at places of grid constraints. Accordingly, the systems for automatically generating heating capacity or cooling capacity from a waste water source as described herein are not limited to use in single buildings.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A self-cleaning waste water filtration device, comprising:
a shell housing comprising one or more waste water inlets, one or more filtered thermal, water outlets, one or more waste outlets, and one or more spray nozzles;
a filter panel box rotatably and sealably mounted within the shell housing about an axis, the filter panel box comprising a plurality of filtration chambers, each one of the filtration chambers being fluidically isolated from the other filtration chambers, each of the filtration chambers comprising a filter capable of being contacted with pressurized waste water entering through the one or more waste water inlets when each of the filtration chambers is rotated to a waste water loading position within the shell housing,
wherein each filter is capable of filtering waste water to give rise to filtered thermal water with each filtration chamber and residual waste exterior to each filtration chamber on each filter,
wherein each one of the filtration chambers and the shell housing are configured to be capable of fluidically transporting filtered thermal water through one or more filtered thermal water outlets to minimize contamination by waste, waste water, or both, when each one of the filtration chambers is rotated to one or more filtered thermal water outlet positions in the shell housing,
wherein each one of the filtration chambers is capable of being backwashed with backwashing water entering through a backwashing inlet through the shell housing when each one of the filtration chambers is rotated to one or more backwashing positions, the spray nozzles capable of spraying spray water at each filter to assist in the removal of at least a portion of the waste from the filter when each one of the filtration chambers is rotated to one or more backwashing positions,
wherein the waste outlets are configured to fluidically transport the waste, backwashing water, and spray water out of the shell housing.

2. The self-cleaning waste water filtration device of claim 1, wherein the shell housing is substantially cylindrical.

3. The self-cleaning waste water filtration device of claim 1, wherein the filter panel box comprises from three to sixteen filtration chambers.

4. The self-cleaning waste water filtration device of claim 3, wherein the filter panel box comprises four to twelve filtration chambers.

5. The self-cleaning waste water filtration device of claim 4, wherein the filter panel box comprises four filtration chambers azimuthally positioned around the axis of the filter panel box.

6. The self-cleaning waste water filtration device of claim 1, wherein the filter panel box is sealably mounted within the shell housing at vertices formed by adjacent filtration chambers, the vertices capable of forming a slidable seal with an inner surface of the shell housing.

7. A method for continuously generating filtered thermal water from waste water, the method comprising:
transporting pressurized waste water into a filtration device, the filtration device comprising a filter panel box capable of rotating about an axis within the filtration device, the filter panel box comprising a plurality of filtration chambers azimuthally positioned about the axis;
rotating the filter panel box about the axis to give rise to one or more of the filtration chambers being in a waste water loading position to receive and filter waste water through a filter mounted on each of the one or more filtration chambers, and to give rise to at least one of the other filtration chambers being in a backwashing position;
filtering the waste water through the filter to generate filtered thermal water within the one or more filtration chambers and residual waste on each of the filters;
backwashing the one or more filtration chambers with backwashing water in the backwashing position;
removing residual waste from the exterior surface of the filter with spray water; and discharging the backwashing water, waste and spray water.

8. The method of claim 7, wherein the backwashing water comprises filtered thermal water.

9. The method of claim 7, wherein the spray water comprises clean water.

10. The method of claim 7, wherein the filter box comprises four filtration champers.

11. The method of claim 10, wherein two of the filtration chambers are adjacent to each other and positioned in the waste water loading position, while a third filtration chamber is positioned in the backwashing position.

12. The method of claim 7, further comprising the step of reducing pressure in a filtration chamber prior to rotating that filtration chamber into the wastewater loading position.

13. The method of claim 7, further comprising the step of removing filtered thermal water from the one or more filtration chambers in the waste water loading positions.

14. The method of claim 7, wherein the filter panel box is rotated continuously.

15. The methods of claim 7, wherein the filter panel box is rotated continuously.

16. The method of claim 15, wherein the filter panel box is rotated up to 180 degrees before stopping.

17. The method of claim 16, wherein the filter panel box is rotated up to 120 degrees before stopping.

18. The method of claim 16, wherein the filter panel box is rotated up to 90 degrees before stopping.

19. The method of claim 16, wherein the filter panel box is rotated up to 60 degrees before stopping.

20. The method of claim 7, wherein filter panel box comprises two ends orthogonal to the axis, one of the two ends being fluidically sealed, and the other end transporting filtered thermal water out of the one or more filtration chambers in the waste water loading position.

21. The method of claim 20, wherein the other end also transports backwashing water into the one or more filtration chambers in the backwashing position.

22. A system for automatically generating heating capacity or cooling capacity from waste water, comprising:
a heat pump; and
a self-cleaning waste water filtration device for generating filtered thermal water to be used as the heating fluid source, the cooling fluid source, or both, for the heat pump, the self-cleaning waste water filtration device comprising:
a shell housing comprising one or more waste water inlets, one or more filtered thermal water outlets, one or more waste outlets, and one or more spray nozzles;
a filter panel box rotatably and sealably mounted within the shell housing about an axis, the filter panel box comprising a plurality of filtration chambers, each one of the filtration chambers being fluidically isolated from the other filtration chambers, each of the filtration chambers comprising a filter capable of being contacted with pressurized waste water entering through the one or more waste water inlets when each of the filtration chambers is rotated to a waste water loading position within the shell housing,
wherein each filter is capable of filtering waste water to give rise to filtered thermal water within each filtration chamber and residual waste exterior to each filtration chamber on each filter,
wherein each one of the filtration chambers and the shell housing are configured to be capable of fluidically transporting filtered thermal water through one or more filtered thermal water outlets to minimize contamination by waste, waste water, or both, when each one of the filtration chambers is rotated to one or more filtered thermal water outlet positions in the shell housing,
wherein each one of the filtration chambers is capable of being backwashed with backwashing water entering through a backwashing inlet through the shell housing when each one of the filtration chambers is rotated to one or more backwashing positions, the spray nozzles capable of spraying spray water at each filter to assist in the removal of at least a portion of the waste from the filter when each One of the filtration chambers is rotated to one or more backwashing positions,
wherein the waste outlets are configured to fluidically transport the waste, backwashing water, and spray water out of the shell housing; and
conduit capable of fluidically transmitting filtered thermal water from the one or more filtered thermal water outlets to the heat pump.

23. The system of claim 22, wherein the shell housing is substantially cylindrical.

24. The system of claim 22, wherein the filter panel box comprises from three to sixteen filtration chambers.

25. The system of claim 24, wherein the filter panel box comprises four to twelve filtration chambers.

26. The system of claim 25, wherein the filter panel box comprises four filtration chambers azimuthally positioned around the axis of the filter panel box.

27. The system of claim 22, wherein the filter panel box is sealably mounted within the shell housing at vertices formed by adjacent filtration chambers, the vertices capable of forming a slidable seal with an inner surface of the shell housing.

28. The system of claim 22, wherein the system is configured so that at least a portion of the filtered thermal water exiting the heat pump is used as the backwashing water in the self-cleaning waste water filtration device.

29. The system of claim 22, wherein the waste water comprises raw sewage, sewage that is at least partially processed, industrial waste, gray water, black water, process cooling water, ground water, river water, lake water, ocean water, shale processing frac water, or any combination thereof.

30. A method for producing and transporting filtered thermal water from a waste water source to a heat pump, the filtered thermal water to be used for heating, cooling, or both, the method comprising:
transporting pressurized waste water from the waste water source into a filtration device, the filtration device comprising a filter panel box capable of rotating about an axis within the filtration device, the filter panel box comprising a plurality of filtration chambers azimuthally positioned about the axis;
rotating the filter panel box about the axis to give rise to one or more of the filtration chambers being in a waste water loading position to receive and filter waste water through a filter mounted oh each of the one or more filtration chambers, and to give rise to at least one of the other filtration chambers being in a backwashing position;
filtering the waste water through the filter to generate filtered thermal water within the one or more filtration chambers and residual waste on each of the filters;
backwashing the one or more filtration chambers with backwashing water in the backwashing position;
removing residual waste from the exterior surface of the filter with spray water;
discharging the backwashing water, waste and spray water, and
transporting the filtered thermal water to the heat pump as a thermal fluid source.

31. The method of claim 30, wherein the backwashing water comprises filtered thermal water returned from the heat pump.

32. The method of claim 30, wherein the spray water comprises clean water.

33. The method of claim 30, wherein the filter box comprises four filtration chambers.

34. The method of claim 33, wherein two of the filtration chambers are adjacent to each other and positioned in the waste water loading position, while a third filtration chamber is positioned in the backwashing position.

35. The method of claim 30, further comprising the step of reducing pressure in a filtration chamber prior to rotating that filtration chamber into the waste water loading position.

36. The method of claim 30, further comprising the step of removing filtered thermal water from the one or more filtration chambers in the waste water loading positions.

37. The method of claim 30, wherein the filter panel box is rotated continuously.

38. The methods of claim 30, wherein the filter panel box is rotated discontinuously.

39. The method of claim 38, wherein the filter panel box is rotated up to 180 degrees before stopping.

40. The method of claim 39, wherein the filter panel box is rotated up to 120 degrees before stopping.

41. The method of claim 39, wherein the filter panel box is rotated up to 90 degrees before stopping.

42. The method of claim 39, wherein the filter panel box is rotated up to 60 degrees before stopping.

43. The method of claim 30, wherein filter panel box comprises two ends orthogonal to the axis, one of the two ends being fluidically sealed, and the other end transporting filtered thermal water out of the one or more filtration chambers in the waste water loading position.

44. The method of claim 43, wherein the other end also transports backwashing water into the one or more filtration chambers in the backwashing position.

45. The method of claim 30, wherein the backwashing water, waste and spray water are discharged downstream from the waste water source.

46. The method of claim 30, wherein the waste water source comprises raw sewage, sewage that is at least partially processed, industrial waste, process cooling water, river water, lake water, ocean water, shale processing frac water, or any combination thereof.

47. The method of claim 30, further comprising waste water from the waste water source at least partially filling a holding tank, wherein at least a portion of the waste water in the holding tank is fluidically transported to the filtration device.

48. The method of claim 47, wherein the waste water source comprises a sewage line and the waste water comprises sewage.

49. The method of claim 47, further comprising fluidically transporting at least a portion of the filtered thermal water from the heat pump, from the filtration device, or both, into the holding tank.
